(19) United States
(12) Patent Application Publication
(10) Pub. No.: US 2026/0254055 A1
(43) Pub. Date: Aug. 27, 2026

(54) Secondary Battery

(71) Applicant: Nissan Motor Co., Ltd., Yokohama-shi, Kanagawa (JP)

(72) Inventor: Yusuke Otsuka, Kanagawa (JP)

(21) Appl. No.: 18/992,489

(22) PCT Filed: Jul. 14, 2022
(86) PCT No.: PCT/IB2022/000405

§ 371 Date: Jan. 8, 2025

(51) Int. Cl. H01M 50/491; H01M 10/0562; H01M 10/0585; H01M 50/44; H01M 50/454

(52) U.S. Cl. CPC H01M 50/491; H01M 10/0562; H01M 10/0585; H01M 50/44; H01M 50/454

(57) ABSTRACT

A secondary battery comprises a porous body, a positive electrode and a negative electrode. The porous body has an electrolyte region which is loaded with a solid electrolyte and a non-loaded region which is not loaded with a solid electrolyte. The non-loaded region has a non-communication region in which both sides of the porous body in the stacking direction are not in communication with each other. The non-communication region is provided in a position where the non-communication region is continued to the outer peripheral part of the electrolyte region and surrounds the electrolyte region.

### TECHNICAL FIELD

The present invention relates to a secondary battery.

### BACKGROUND ART

There is known a secondary battery in which a positive electrode and a negative electrode are provided so as to sandwich an electrolyte layer therebetween, and charging and discharging are performed by lithium ions moving between the positive electrode and the negative electrode. As such a secondary battery, a secondary battery having a configuration in which a solid electrolyte is supported on a sheet-shaped porous body is known. By supporting the solid electrolyte on the porous body, it is possible to obtain an electrolyte layer that is self-standing even when the electrolyte layer is thin.

A technique related to the above is disclosed in, for example, Patent Literature 1 (JP2021-533542A). Patent Literature 1 discloses a method for manufacturing a solid electrolyte membrane for an all-solid-state battery, the method including: a step of preparing a laminated structure by sequentially laminating a first protective layer, a film-like first solid electrolyte material, a porous base material, a film-like second solid electrolyte material, and a second protective layer; a step of pressurizing the laminated structure to push the first solid electrolyte material and the second solid electrolyte material into the porous base material to fill pores of the porous base material with the solid electrolyte materials; and a step of removing the first protective layer and the second protective layer, in which the pressurization is performed by a roll pressing method. Since the solid electrolyte membrane is a composite of a porous polymeric material such as a nonwoven fabric and a solid electrolyte material, the solid electrolyte membrane can be manufactured in a form of a thin film having a thickness of 70 μm or less while having excellent strength, and is advantageous in improving an energy density of the battery.

### SUMMARY OF INVENTION

In the secondary battery in which lithium ions are used for charging and discharging, lithium dendrites may grow from the negative electrode during charging. When the lithium dendrites grow to wrap around an end portion of the electrolyte layer, the positive electrode and the negative electrode are short-circuited. This problem may also occur in the secondary battery having a configuration in which a solid electrolyte is supported on a porous body.

Therefore, an object of the present invention is to provide a technique capable of preventing a short circuit caused by lithium dendrites in a secondary battery having a configuration in which a solid electrolyte is supported on a porous body.

### BRIEF DESCRIPTION OF DRAWINGS

FIG. 1 is a cross-sectional view schematically illustrating a secondary battery according to a first embodiment.

FIG. 2 is a plan view illustrating a porous body.

FIG. 3 is a schematic cross-sectional view illustrating a secondary battery according to a second embodiment.

FIG. 4 is a schematic cross-sectional view illustrating a secondary battery according to a third embodiment.

FIG. 5 is a schematic cross-sectional view illustrating a secondary battery according to a fourth embodiment.

FIG. 6 is a schematic cross-sectional view illustrating a secondary battery according to a fifth embodiment.

FIG. 7 is a schematic cross-sectional view illustrating a secondary battery according to a sixth embodiment.

FIG. 8 is a schematic cross-sectional view illustrating an example of a secondary battery according to a seventh embodiment.

FIG. 9 is a schematic view illustrating another example of the secondary battery according to the seventh embodiment.

### DESCRIPTION OF EMBODIMENTS

Hereinafter, embodiments of the present invention will be described with reference to the drawings.

### First Embodiment

A secondary battery 1 according to the present embodiment is a secondary battery in which charging and discharging are performed by movement of lithium ions. The secondary battery 1 is a so-called all-solid-state battery.

### Outline

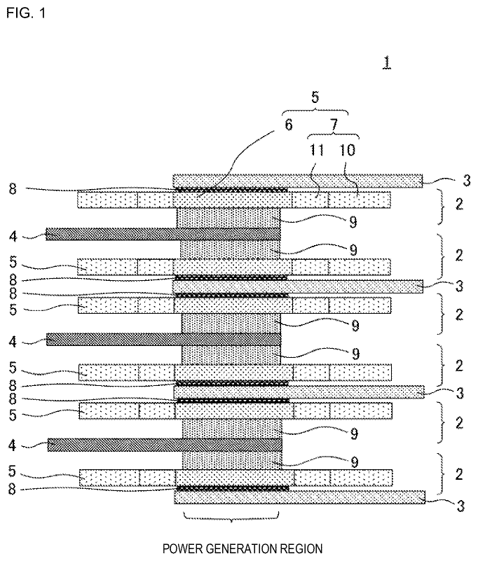

FIG. 1 is a cross-sectional view schematically illustrating the secondary battery 1 according to the present embodiment. As illustrated in FIG. 1, the secondary battery 1 has a configuration in which a plurality of battery cells 2 are laminated. Specifically, the secondary battery 1 is provided with a plurality of positive electrode current collector foils 4 and a plurality of negative electrode current collector foils 3. The plurality of positive electrode current collector foils 4 and the plurality of negative electrode current collector foils 3 are alternately disposed in a lamination direction.

Each of the battery cells 2 is provided between the positive electrode current collector foil 4 and the negative electrode current collector foil 3 that are adjacent to each other. Each of the battery cells 2 includes a positive electrode 9, a negative electrode 8, and an electrolyte region 6. The electrolyte region 6 is a region provided in a sheet-like porous body 5, and is a region on which a solid electrolyte is supported. The electrolyte region 6 is sandwiched between the positive electrode 9 and the negative electrode 8. In other words, the positive electrode 9 and the negative electrode 8 are disposed above and below the porous body 5 so as to sandwich the electrolyte region 6. The positive electrode 9 is provided between the electrolyte region 6 and the positive electrode current collector foil 4, and the negative electrode 8 is provided between the electrolyte region 6 and the negative electrode current collector foil 3.

Outer shapes of the positive electrode 9, the negative electrode 8, and the electrolyte region 6 when viewed along the lamination direction substantially coincide with each other. However, it is not necessary for those to completely coincide with each other, and those may be slightly different.

The secondary battery 1 described above generates power in a region where the positive electrode 9, the negative electrode 8, and the electrolyte region 6 overlap (hereinafter, may be referred to as a power generation region). Specifically, during charging, lithium ions are conducted from a positive electrode 9 side to a negative electrode 8 side via the electrolyte region 6, and the lithium ions are absorbed in the negative electrode 8 side. Alternatively, lithium is deposited on the negative electrode 8 side. On the other hand, during discharging, lithium ions move from the negative electrode 8 side to the positive electrode 9 side, and lithium is absorbed in the positive electrode 9.

In such a secondary battery 1, as described above, lithium dendrites may grow from an end portion of the negative electrode 8. When the lithium dendrites grow to wrap around an end portion of the electrolyte region 6, the positive electrode 9 and the negative electrode 8 are short-circuited. Therefore, in the present embodiment, a configuration of the porous body 5 is devised.

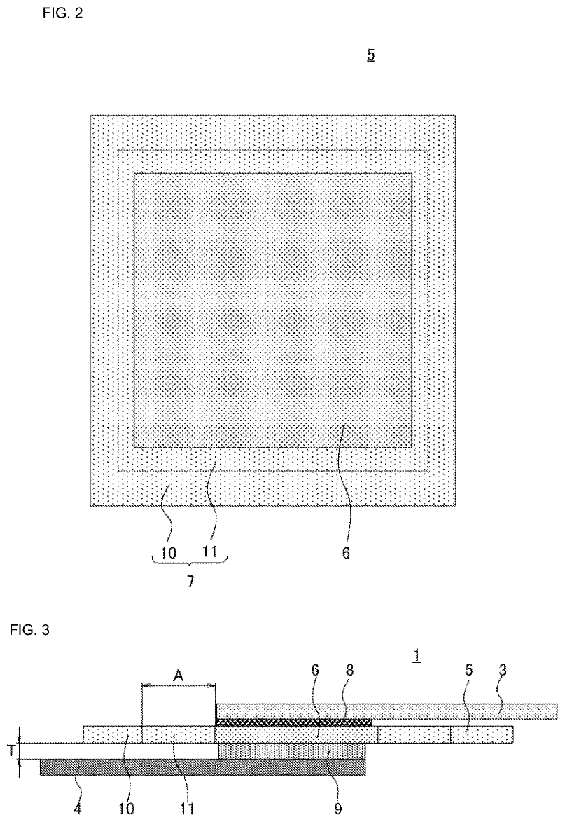

FIG. 2 is a plan view illustrating the porous body 5. As illustrated in FIGS. 1 and 2, each porous body 5 is provided with a non-supporting region 7 in addition to the electrolyte region 6.

As described above, the electrolyte region 6 is a region on which the solid electrolyte is supported, and is provided in a central portion of each porous body 5. In the electrolyte region 6, communication pores are provided in each porous body 5 such that lithium ions can be conducted. The communication pore is a pore penetrating through each porous body 5. The solid electrolyte is supported in the communication pore.

On the other hand, the non-supporting region 7 is a region where the solid electrolyte is not supported. The non-supporting region 7 is provided in an outer peripheral portion of each porous body 5 and surrounds the electrolyte region 6.

The non-supporting region 7 is provided with a communicating region 10 and a non-communicating region 11.

The communicating region 10 is a region in which both sides of the porous body 5 communicate with each other in the lamination direction. Specifically, both sides of the porous body 5 communicate with each other through the communication pores.

On the other hand, the non-communicating region 11 is a region in which both sides of the porous body 5 do not communicate with each other in the lamination direction. The non-communicating region 11 is provided at a position surrounding the electrolyte region 6 and is continuous with an outer peripheral portion of the electrolyte region 6. The non-communicating region 11 may be, for example, a region in which the porous body 5 itself has no communication pores. Alternatively, the non-communicating region 11 may be a region in which a communication pore exists in the porous body 5 itself but the communication pore is closed.

According to the configuration described above, since the non-communicating region 11 is provided, it is possible to prevent the growth of the lithium dendrites that wrap around the end portion of the electrolyte region 6. In a case where the non-communicating region 11 is not provided, that is, in a case where upper and lower portions of the porous body 5 communicate with each other in a region outside the electrolyte region 6, lithium dendrites are likely to grow so as to penetrate the porous body 5. Therefore, a short circuit between the negative electrode 8 and the positive electrode 9 due to the lithium dendrites may become a problem. However, in the present embodiment, since the non-communicating region 11 is provided outside the electrolyte region 6, the growth of the lithium dendrites that short-circuit the positive electrode 9 and the negative electrode 8 can be prevented.

Next, each part of the secondary battery 1 according to the present embodiment will be described in detail.

### Porous Body

A material of the porous body 5 is not particularly limited as long as the material can support the solid electrolyte. For example, the porous body 5 can be prepared by the following materials and methods.

First, a porous sheet having communication pores is prepared. As the porous sheet having communication pores, for example, a nonwoven fabric, a porous separator, a sheet in which communication pores are formed by lithography, or the like can be used. As the nonwoven fabric, for example, polyester nonwoven fabric, polyethylene nonwoven fabric, and cellulose fiber nonwoven fabric can be used.

Subsequently, a slurry including a solid electrolyte is applied to a region where the electrolyte region 6 is to be formed, and dried. Thus, the electrolyte region 6 is formed.

In addition, the communication pores are blocked around the electrolyte region 6 to form the non-communicating region 11. For example, in a case where a material that melts by heat is used as the porous sheet, the communication pores can be blocked by partially heating and melting the porous sheet. Alternatively, the communication pores can also be blocked by filling the porous sheet with a resin material or the like such that the communication pores are filled. Alternatively, as will be described in the embodiments to be described later, the communication pores can be blocked by disposing a coating material on an upper surface or a lower surface of the porous sheet.

The above is an example of the method for preparing the porous body 5 in a case where the porous sheet having the communication pores is used.

On the other hand, the porous body 5 can also be prepared using a porous sheet originally having no communication pores (for example, a porous sheet having closed pores). In this case, first, communication pores are formed only in a partial region (a region to be the electrolyte region 6 and the communicating region 10) by lithography or the like. Next, a slurry containing a solid electrolyte is applied to the region to be the electrolyte region 6 and dried. Thus, the electrolyte region 6 is formed. Even when such a method is used, the porous body 5 having the electrolyte region 6, the communicating region 10, and the non-communicating region 11 can be obtained.

A thickness of the porous body 5 is not particularly limited. For example, the thickness of the porous body 5 is 5 μm to 100 μm, and preferably 20 μm to 60 μm in the electrolyte region 6.

The solid electrolyte supported on the porous body 5 may be any electrolyte that is solid and functions as an electrolyte. As the solid electrolyte, for example, a sulfide solid electrolyte and an oxide solid electrolyte can be used. Preferably, the solid electrolyte is a sulfide solid electrolyte. Examples of the sulfide solid electrolyte include LPS-based materials (for example, argyrodite (Li₆PS₅Cl)) and LGPS-based materials (for example, Li₁₀GeP₂S₁₂).

### Positive Electrode

The positive electrode 9 may be formed of a material capable of releasing lithium ions during charging and absorbing lithium ions during discharging. The positive electrode 9 is formed of, for example, a material containing a resin binder and a positive electrode active material dispersed in the resin binder. As the positive electrode active material, for example, a lithium metal composite oxide can be used. Examples of the lithium metal composite oxide include layered rock salt compounds such as LiCoO₂, LiMnO₂, LiNiO₂, LiVO₂, and Li(Ni—Mn—Co)O₂; spinel compounds such as LiMn₂O₄, and LiNi_{0.5}Mn_{1.5}O₄; olivine compounds such as LiFePO4, and LiMnPO₄; and Si-containing compounds such as Li₂FeSiO₄, and Li₂MnSiO₄. In addition, Li₄Ti₅O₁₂ or the like can also be used.

A thickness of the positive electrode 9 is not particularly limited, and is, for example, 10 μm to 500 μm, preferably 50 μm to 200 μm.

### Negative Electrode

The negative electrode 8 may be configured to be able to absorb lithium (or to precipitate lithium) during charging and to release lithium ions during discharging. For example, the negative electrode 8 can be formed of a material containing a resin binder and a negative electrode active material dispersed in the resin binder. As the negative electrode active material, for example, a lithium metal, a silicon material (silicon), a tin material, a compound containing silicon or tin (oxide, nitride, and alloy with other metals), and a carbon material (graphite or the like) can be used.

The secondary battery 1 according to the present embodiment may be a so-called “fully deposited” secondary battery. The fully deposited secondary battery is a battery configured such that lithium as the negative electrode active material is not contained on a negative electrode side in a fully discharged state, lithium ions move from a positive electrode side to the negative electrode side during charging, and a lithium metal is deposited on the negative electrode current collector foil 3. In such a battery, at least the lithium metal deposited on the negative electrode side during charging functions as the negative electrode 8, and thus is included in the secondary battery 1 of the present invention.

In a fully deposited secondary battery 1, a negative electrode intermediate layer may be disposed between the solid electrolyte layer and the negative electrode current collector foil. The negative electrode intermediate layer is a layer interposed between the precipitated lithium metal and the solid electrolyte layer. The negative electrode intermediate layer contains a lithium reactive material. Examples of the lithium reactive material include a material capable of absorbing and releasing lithium ions during charging and a metal capable of being alloyed with lithium during charging.

The material capable of absorbing and releasing lithium ions is not particularly limited, and is preferably a carbon material. Specific examples of the carbon material include carbon black (specific examples thereof include acetylene black, Ketjen black (registered trademark), furnace black, channel black, and thermal lamp black), carbon nanotube (CNT), graphite, and hard carbon. Among those, carbon black is preferable, and at least one selected from the group consisting of acetylene black, Ketjen black (registered trademark), furnace black, channel black, and thermal lamp black is more preferable.

Examples of the metal capable of being alloyed with lithium include In, Al, Si, Sn, Mg, Au, Ag, and Zn. Among those, In, Si, Sn, and Ag are preferable, and Ag is more preferable.

The lithium reactive material may be used alone or in combination of two or more thereof. As a form of using the lithium reactive material in combination of two or more thereof, it is also preferable to use a material capable of absorbing and releasing lithium ions and a metal capable of alloying with lithium in combination. As a result, it is possible to ensure sufficient strength and lithium ion conductivity of the negative electrode intermediate layer. More specifically, it is preferable to use nanoparticles consisting of In, Si, Sn, or Ag in combination with carbon black, and it is more preferable to use nanoparticles consisting of Ag in combination with carbon black. A blending ratio (mass ratio) of the material capable of absorbing and releasing lithium ions and the metal capable of being alloyed with lithium is not particularly limited, and the blending ratio (mass ratio) of the material capable of absorbing and releasing lithium ions: the metal capable of being alloyed with lithium is preferably 10:1 to 1:1, and more preferably 5:1 to 2:1.

A content of the lithium reactive material in the negative electrode intermediate layer (indicating a total content thereof when two or more kinds of materials are used in combination, and the same applies hereinafter) is not particularly limited, and is preferably in a range of 50 mass% to 100 mass%, more preferably in a range of 70 mass% to 100 mass%, still more preferably in a range of 85 mass% to 99 mass%, and particularly preferably in a range of 90 mass% to 100 mass%.

The negative electrode intermediate layer may be formed of only the lithium reactive material as long as a self-supporting film can be formed of only the lithium reactive material, or may include a binder as necessary. A type of the binder is not particularly limited, and those known in the present technical field can be appropriately adopted. Examples thereof include polyvinylidene difluoride (PVDF) (containing a compound in which a hydrogen atom is substituted with another halogen element), polytetrafluoroethylene (PTFE), styrene-butadiene rubber (SBR), and carboxymethyl cellulose.

A content of the binder in the negative electrode intermediate layer is not particularly limited, and is preferably in a range of 1 mass % to 15 mass %, and more preferably in a range of 5 mass % to 10 mass %. When the content of the binder is 1 mass % or more, a negative electrode intermediate layer having sufficient strength can be formed. When the content of the binder is 15 mass % or less, a negative electrode intermediate layer having sufficient lithium ion conductivity can be formed.

A thickness of the negative electrode intermediate layer is not particularly limited, and is preferably 1 μm to 50 μm, more preferably 5 μm to 40 μm, and still more preferably 10 um to 30 um. When the thickness of the negative electrode intermediate layer is 1 μm or more, a function of the negative electrode intermediate layer can be sufficiently exhibited. When the thickness of the negative electrode intermediate layer is 50 μm or less, a reduction in energy density can be suppressed.

### Positive Electrode Current Collector Foil and Negative Electrode Current Collector Foil

The positive electrode current collector foil 4 and the negative electrode current collector foil 3 are provided to electrically connect the secondary battery 1 to an external device. As illustrated in FIG. 1, the positive electrode current collector foil 4 and the negative electrode current collector foil 3 extend so as to protrude laterally from the power generation region. The positive electrode current collector foil 4 and the negative electrode current collector foil 3 are each formed of a conductive thin film. As the positive electrode current collector foil 4, for example, an aluminum foil can be used. As the negative electrode current collector foil 3, for example, a stainless thin film or a copper thin film can be used.

### Manufacture Example

A method for manufacturing the secondary battery 1 according to the present embodiment is not particularly limited. Hereinafter, a specific method for manufacturing the secondary battery 1 according to the present embodiment will be described by way of example.

### [Preparation of Positive Electrode]

A positive electrode active material, a sulfide solid electrolyte, a conductive auxiliary, a binder, and xylene are weighed in predetermined amounts and mixed to prepare a slurry. The prepared slurry is applied to a carbon-coated aluminum foil (positive electrode current collector foil 4). The slurry is applied to both surfaces in a predetermined region. After the application, drying is performed. Thus, a positive electrode current collector foil 4 on which a positive electrode 9 having a thickness of 200 μm (100 μm on one surface) is formed is obtained.

### [Preparation of Porous Body Supporting Solid Electrolyte]

A sulfide solid electrolyte, a binder, and xylene are weighed in predetermined amounts and mixed to prepare a slurry. The prepared slurry is directly applied to a 40 μm porous sheet (having communication pores) and dried. Thus, the solid electrolyte is supported on the porous sheet to form the electrolyte region 6. Further, a coating material is disposed in a predetermined region to form the non-communicating region 11. Thus, the porous body 5 is obtained.

### [Preparation of Negative Electrode]

A negative electrode active material, a binder, and N-methylpyrolidone (NMP) are weighed in predetermined amounts and mixed to prepare a slurry. The prepared slurry is applied to a SUS foil (negative electrode current collector foil 3). The slurry is applied to both surfaces in a predetermined region. After the application, drying is performed. Thus, a negative electrode current collector foil 3 on which a negative electrode 8 having a thickness of 100 μm (50 μm on one surface) is formed is obtained.

[Preparation of Positive Electrode/Solid Electrolyte/Negative Electrode Laminate] The negative electrode current collector foil 3 on which the porous body 5 and the negative electrode 8 are formed is disposed above and below the positive electrode current collector foil 4 on which the positive electrode 9 is formed, which is prepared by the above-described procedure. Then, roll pressing is performed to obtain a laminate in which those are laminated.

### [Preparation of Laminate of Cell]

Further, a plurality of the obtained laminates are laminated. Thereafter, an aluminum tab is joined to the positive electrode current collector foil 4 and a Ni-plated copper tab is joined to the negative electrode current collector foil 3 by an ultrasonic welding machine, respectively. Finally, the laminate is put into an aluminum laminate film and vacuum-sealed. Thus, a secondary battery 1 having a configuration in which a plurality of battery cells 2 are laminated is obtained.

In the above example, a case where the secondary battery 1 includes a plurality of battery cells 2 is described. However, the secondary battery 1 does not necessarily have to include a plurality of battery cells 2, and the secondary battery 1 may be configured by a single battery cell 2.

The first embodiment has been described above. The configuration and operations and effects of the secondary battery 1 according to the present embodiment are summarized as follows.

The secondary battery 1 according to the present embodiment includes: the porous body 5 having the electrolyte region 6 on which the solid electrolyte is supported and the non-supporting region 7 on which the solid electrolyte is not supported; and the positive electrode 9 and the negative electrode 8 disposed above and below the porous body 5 so as to sandwich the electrolyte region 6. The non-supporting region 7 has the non-communicating region 11 in which both sides of the porous body 5 in the lamination direction do not communicate with each other. The non-communicating region 11 is continuous with the outer peripheral portion of the electrolyte region 6 and is provided at the position surrounding the electrolyte region 6. According to such a configuration, since the region surrounding the electrolyte region 6 is the non-communicating region 11, the growth of the lithium dendrites that wrap around the end portion of the electrolyte region 6 is suppressed. Accordingly, the short circuit between the positive electrode 9 and the negative electrode 8 can be prevented.

### Second Embodiment

Next, a second embodiment will be described. As for a matter for which the same configuration as that of the first embodiment can be adopted, a description thereof is omitted.

FIG. 3 is a schematic cross-sectional view illustrating a main part of a secondary battery 1 according to the second embodiment. In the present embodiment, a width (A in FIG. 3) of the non-communicating region 11 is equal to or larger than a thickness (T in FIG. 3) of the positive electrode 9.

Vibration or the like may be applied to the secondary battery 1. As a result, the negative electrode current collector foil 3 and the porous body 5 may bend toward the positive electrode 9 side, and the negative electrode current collector foil 3 may approach the positive electrode 9 side. When the negative electrode current collector foil 3 approaches the positive electrode 9, a short circuit due to lithium dendrites is likely to occur.

However, in the present embodiment, since the width of the non-communicating region 11 is equal to or larger than the thickness of the positive electrode 9, the positive electrode 9 and the negative electrode current collector foil 3 are still separated from each other by the non-communicating region 11 even when the negative electrode current collector foil 3 and the porous body 5 are bent. Therefore, the short circuit due to the lithium dendrites hardly occurs even when the negative electrode current collector foil 3 and the porous body 5 are bent.

### Third Embodiment

Next, a third embodiment will be described. As for a matter that a same configuration as that of the first embodiment can be adopted, a description thereof is omitted.

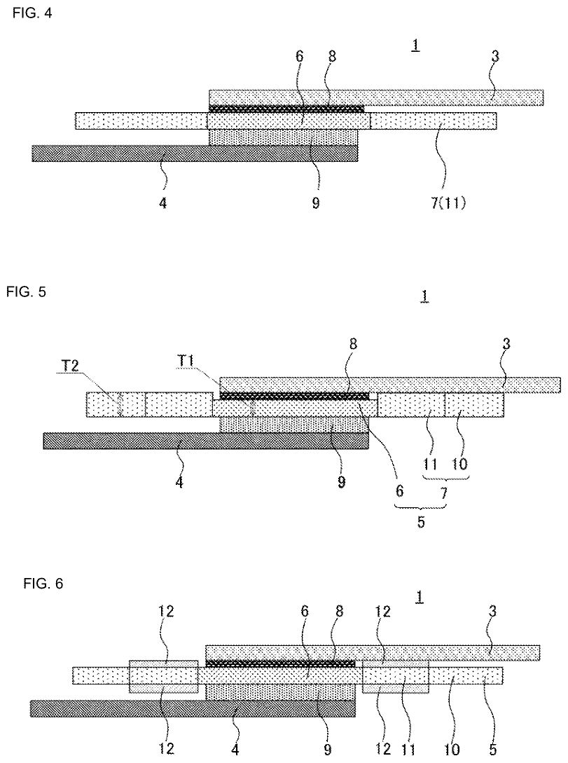

FIG. 4 is a schematic cross-sectional view illustrating a secondary battery 1 according to the third embodiment. As illustrated in FIG. 4, in the present embodiment, in the porous body 5, the entire non-supporting region 7 is the non-communicating region 11. That is, the communicating region 10 does not exist in the non-supporting region 7.

According to the present embodiment, since the entire non-supporting region 7 is the non-communicating region 11, a growth of lithium dendrites that wrap around the electrolyte region 6 is more reliably prevented.

### Fourth Embodiment

Next, a fourth embodiment will be described. As for a matter that same configurations as those of the above-described embodiments can be adopted, descriptions thereof are omitted.

FIG. 5 is a schematic cross-sectional view illustrating a secondary battery 1 according to the fourth embodiment. As illustrated in FIG. 5, in the present embodiment, a thickness of the porous body 5 is devised. Specifically, a thickness (T2 in the drawing) of the porous body 5 in the non-supporting region 7 is larger than a thickness (T1 in the drawing) of the porous body 5 in the electrolyte region 6.

According to the present embodiment, in a region around the electrolyte region 6, a thickness of a structure (that is, the porous body 5) separating the positive electrode side and the negative electrode side is increased. Therefore, the growth of the lithium dendrites is likely to be prevented. Accordingly, the short circuit can be more reliably prevented.

### Fifth Embodiment

Next, a fifth embodiment will be described. As for a matter that same configurations as those of the above-described embodiments can be adopted, descriptions thereof are omitted.

FIG. 6 is a schematic cross-sectional view illustrating a secondary battery 1 according to the fifth embodiment. As illustrated in FIG. 6, coating materials 12 are provided on an upper surface and a lower surface of the porous body 5 in the non-communicating region 11. That is, in the non-communicating region 11, the communication pores of the porous body 5 are blocked by the coating material 12. The coating material 12 is not particularly limited, and for example, a tape material (polyimide film or the like), a coating agent, an inorganic particle material, or the like can be used.

According to the present embodiment, in a region outside the electrolyte region 6, the thickness of the porous body 5 is substantially larger than that of the coating material 12. Therefore, the growth of the lithium dendrites is likely to be prevented in the same manner as in the fourth embodiment. Therefore, the short circuit can be more reliably prevented.

In the example illustrated in FIG. 6, the coating materials 12 are provided on both the upper surface and the lower surface of the porous body 5. However, the coating materials 12 may be provided only on one surface side of the porous body 5. In this case, since lithium dendrites grow from the negative electrode 8 side, it is preferable that the coating materials 12 be provided on a surface of the porous body 5 on the negative electrode 8 side.

### Sixth Embodiment

Next, a sixth embodiment will be described. The present embodiment is a modification of the fifth embodiment. As for a matter that a same configuration as that of the fifth embodiment can be adopted, a description thereof is omitted.

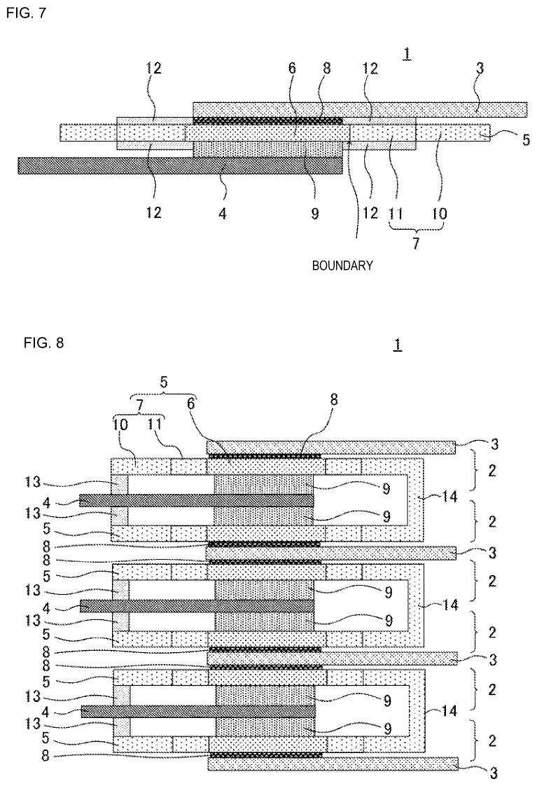

FIG. 7 is a schematic cross-sectional view illustrating a secondary battery 1 according to the sixth embodiment. As illustrated in FIG. 7, in the present embodiment, the coating materials 12 are disposed so as to cover a boundary between the electrolyte region 6 and the non-supporting region 7.

In the end portion of the electrolyte region 6, a binding force of the solid electrolyte in the porous body 5 is often weakened. As a result, the solid electrolyte may fall off from the porous body 5, and a space penetrating vertically through the porous body 5 may be formed. As a result, lithium dendrites may grow so as to penetrate vertically through the porous body 5, and the positive electrode 9 and the negative electrode 8 may be short-circuited.

However, according to the present embodiment, the boundary between the electrolyte region 6 and the non-supporting region 7 is protected by the coating materials 12. Accordingly, the solid electrolyte can be prevented from falling off, and the short circuit can be more reliably prevented.

### Seventh Embodiment

Next, a seventh embodiment will be described. As for a matter that same configurations as those of the above-described embodiments can be adopted, descriptions thereof are omitted. In the present embodiment, at least one side surface of the positive electrode 9 and the negative electrode 8 is at least partially covered with the porous body 5.

FIG. 8 is a schematic cross-sectional view illustrating an example of the secondary battery 1 according to the present embodiment. In this example, one porous body 5 is commonly used between two adjacent battery cells 2. Specifically, each porous body 5 is bent so as to wind the positive electrode current collector foil 4 and the positive electrode 9 (see a folded portion 14 in the drawing). A lower side portion of each porous body 5 is sandwiched between the positive electrode 9 and the negative electrode 8 in the battery cell 2 on a lower side, and an upper side portion thereof is sandwiched between the positive electrode 9 and the negative electrode 8 in the battery cell 2 on an upper side. In addition, in each porous body 5, an outer peripheral portion of the upper side portion overlaps an outer peripheral portion of the lower side portion. The overlapping outer peripheral portions are closed by an adhesive 13 (for example, a tape material). In a portion where the positive electrode current collector foil 4 exists, the outer peripheral portions of each porous body 5 are bonded to the positive electrode current collector foil 4. With such a configuration, a side surface of the positive electrode 9 is entirely covered with each porous body 5.

According to the above-described configuration, the negative electrode current collector foil 3 and the positive electrode current collector foil 4 are separated from each other by the porous body 5. Therefore, even when the negative electrode current collector foil 3 or the positive electrode current collector foil 4 is bent, the two do not come into contact with each other. Accordingly, it is possible to prevent a short circuit caused by contact between the negative electrode current collector foil 3 and the positive electrode current collector foil 4. In addition, it is possible to prevent lithium dendrites from growing to wrap around the end portion of the porous body 5.

In the example illustrated in FIG. 8, the porous body 5 is configured to cover the side surface of the positive electrode 9, but the porous body 5 may be bent so as to cover the side surface of the negative electrode 8 instead of that of the positive electrode 9.

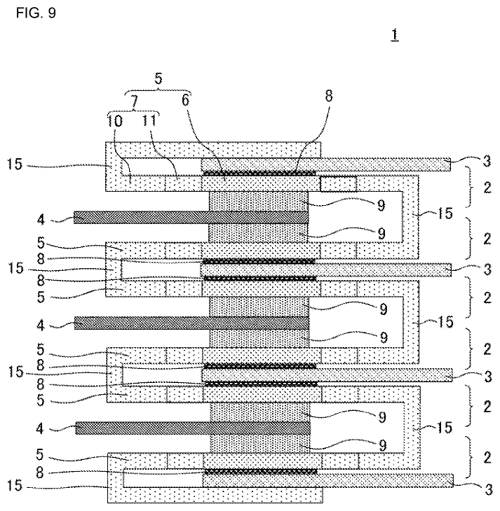

Next, another example of the secondary battery according to the present embodiment will be described. FIG. 9 is a schematic view illustrating another example of the secondary battery 1 according to the present embodiment. In the example illustrated in FIG. 9, the porous bodies 5 in the adjacent battery cells 2 are bonded to each other by thermal fusion bonding in the outer peripheral portions (see thermal fusion bonded portions 15 in FIG. 9). Specifically, the outer peripheral portions of the porous bodies 5 of the upper and lower battery cells 2 are joined to each other by thermal fusion bonding at portions other than portions where the negative electrode current collector foil 3 and the positive electrode current collector foil 4 are provided.

According to the configuration illustrated in FIG. 9, as in the configuration illustrated in FIG. 8, the side surface of the at least one of the positive electrode 9 and the negative electrode 8 is at least partially covered with the porous body 5. Accordingly, it is possible to prevent a short circuit caused by contact between the negative electrode current collector foil 3 and the positive electrode current collector foil 4. In addition, a short circuit due to lithium dendrites can be more reliably prevented.

1. A secondary battery comprising:
a porous body having an electrolyte region on which a solid electrolyte is supported and a non-supporting region on which the solid electrolyte is not supported; and
a positive electrode and a negative electrode disposed above and below the porous body so as to sandwich the electrolyte region, wherein
the non-supporting region has a non-communicating region in which both sides of the porous body in a lamination direction do not communicate with each other,
the non-communicating region is continuous with an outer peripheral portion of the electrolyte region and is provided at a position surrounding the electrolyte region, and an outer shape of the electrolyte region is located outside outer shapes of the positive electrode and the negative electrode when viewed along the lamination direction.

2. The secondary battery according to claim 1, wherein a width of the non-communicating region is equal to or larger than a thickness of the positive electrode.

3. The secondary battery according to claim 1, wherein an entire non-supporting region is the non-communicating region.

4. The secondary battery according to claim 1, wherein a thickness of the porous body at the non-supporting region is larger than a thickness of the porous body at the electrolyte region.

5. The secondary battery according to claim 1, further comprising:
a coating material disposed on an upper surface or a lower surface of the porous body in the non-communicating region.

6. The secondary battery according to claim 5, wherein the coating material is disposed so as to cover a boundary between the electrolyte region and the non-supporting region.

7. The secondary battery according to claim 1, wherein a side of at least one of the positive electrode and the negative electrode is at least partially covered with the porous body.

8. The secondary battery according to claim 1, wherein the porous body is a nonwoven fabric.
